(19) United States
(12) Patent Application Publication
(10) Pub. No.: US 2010/0326745 A1
(43) Pub. Date: Dec. 30, 2010

(54) ELECTRONIC DEVICE WITH STYLUS

(75) Inventor: KUI-JUN WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/548,455

(22) Filed: Aug. 27, 2009

(30) Foreign Application Priority Data
Jun. 26, 2009 (CN) 200910303738.4

(51) Int. Cl. G06F 3/041; G06F 3/033

(52) U.S. Cl. 178/19.01; 345/179

(57) ABSTRACT

An electronic device comprising: a main body and a stylus, wherein the main body comprises: a plurality of triggers; a plurality of power consuming modules; a power supply controlling module; a power supplying module; a storage unit configured for storing a relationship table which records a relationship between the triggers and the power consuming modules, wherein each of the triggers is corresponding to one or more power consuming modules; a socket configured for receiving the stylus; the stylus comprises: a shank and a plurality of protrusions, wherein the protrusions are protruded from the circumferential surface of the shank; wherein when one or more trigger is pressed, the power supply controlling module is configured for identifying the pressed trigger, reading the relationship table from the storage unit, and controlling the power supplying module to supply power for the power consuming module corresponding to the pressed trigger.

### BACKGROUND

1. Technical Field

The present disclosure relates to an electronic device with a stylus.

2. Description of Related Art

In general, electronic devices include a main body and many modules, such as, BLUETOOTH module, and speaker module etc. The different modules each have their own power requirement.

Generally, batteries included in the electronic device supply power for all the modules of the electronic device at the same time. When the batteries run low, none of the modules will get enough power.

Therefore, what is need is an electronic device including a stylus for selectively supplying power to modules.

### BRIEF DESCRIPTION OF THE DRAWINGS

FIG. 1 is an isometric view of an electronic device in accordance with an exemplary embodiment.

FIG. 2 is a block diagram of a hardware infrastructure of the electronic device of FIG.1 in accordance with an exemplary embodiment.

FIG. 3 is a partial, exploded view of the electronic device of FIG. 1.

FIG. 4 is a sectional view of a socket included in the electronic device of FIG. 1.

FIG. 5 is a schematic diagram of the electronic device of FIG. 1 in a power supplying state.

### DETAILED DESCRIPTION

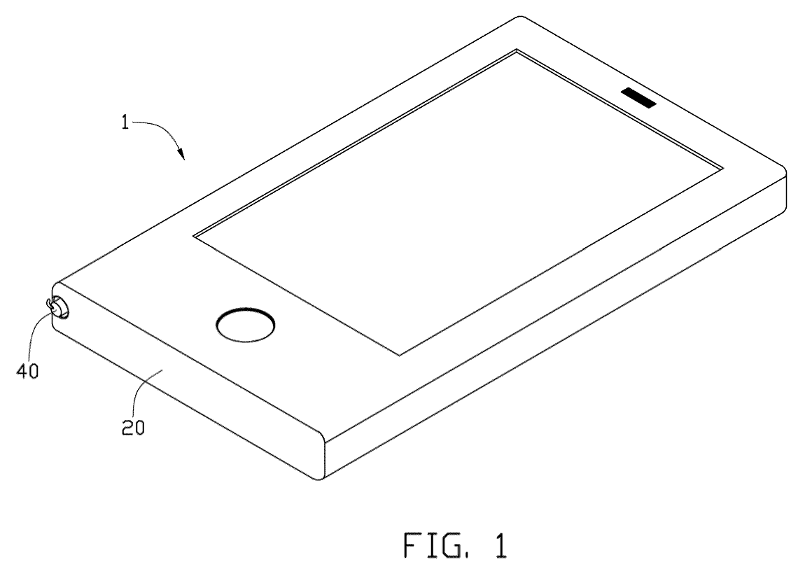

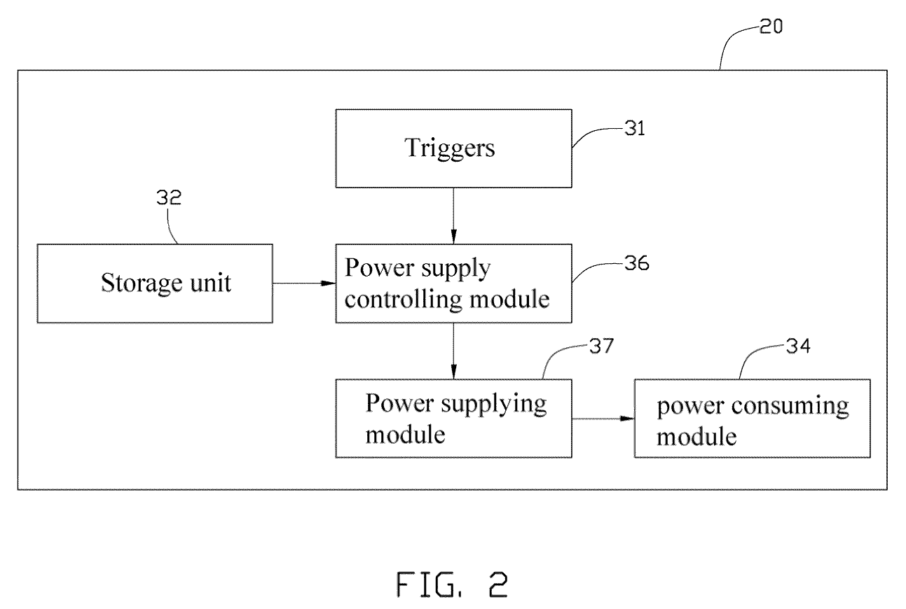

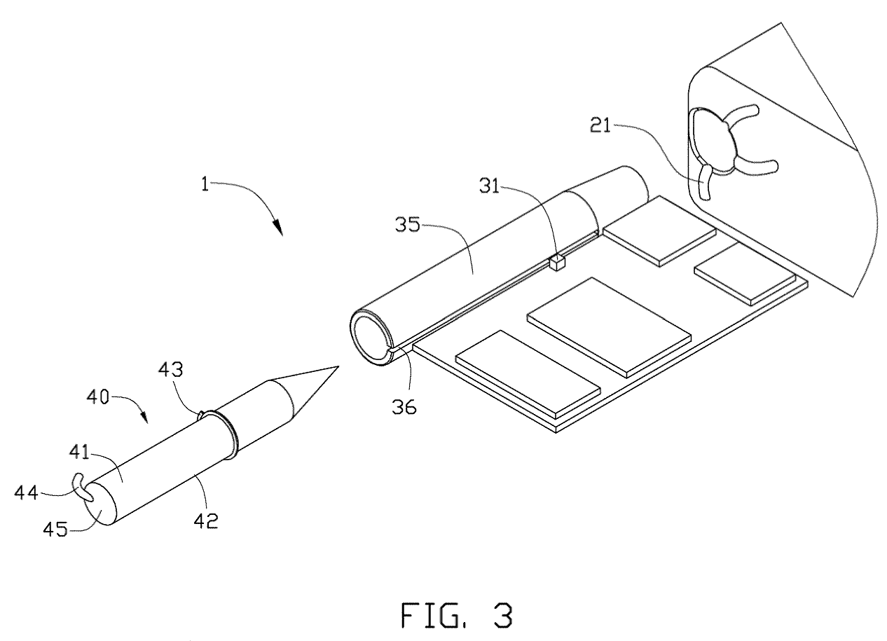

Referring to FIGS. 1-3, an electronic device 1 includes a main body 20, and a stylus 40. The main body 20 includes a plurality of notches 21, a plurality of triggers 31, a storage unit 32, a plurality of power consuming modules 34, a socket 35, a power supply controlling module 36, and a power supplying module 37. The notches 21 are formed in a side plate of the main body 20. In the exemplary embodiment, there are three notches.

The socket 35 is a hollow cylinder formed in a side plate of the electronic device 1. The socket 35 is configured for receiving the stylus 40. The power supply controlling module 36 is configured for controlling the power supplying module 37 to supply power for the power consuming module 34 according to the triggers 31.

The storage unit 32 is configured for storing a relationship table which records a relationship between the triggers 31 and the power consuming modules 34. Wherein, the triggers 31 are associated with the power consuming modules 34 respectively.

The stylus 40 includes a cylindrical shank 41. A ring 42 is extended from the circumferential surface of the shank 41. The ring 42 is made from elastic material. A non-elastic protrusion 43 is protruded from the circumferential surface of the ring 42. A protrusion, such as a hook 44, is formed in an end 45 away from a point of the stylus 40, is aligned with the protrusion 43, and is configured for engaging with one of the notches 21. In other embodiments, the protrusion 43 is made from elastic material, and the ring 42 is not elastic.

In other embodiments, the protrusion 43 may be directly protruded from the circumferential surface of the shank 41, and the ring 42 omitted.

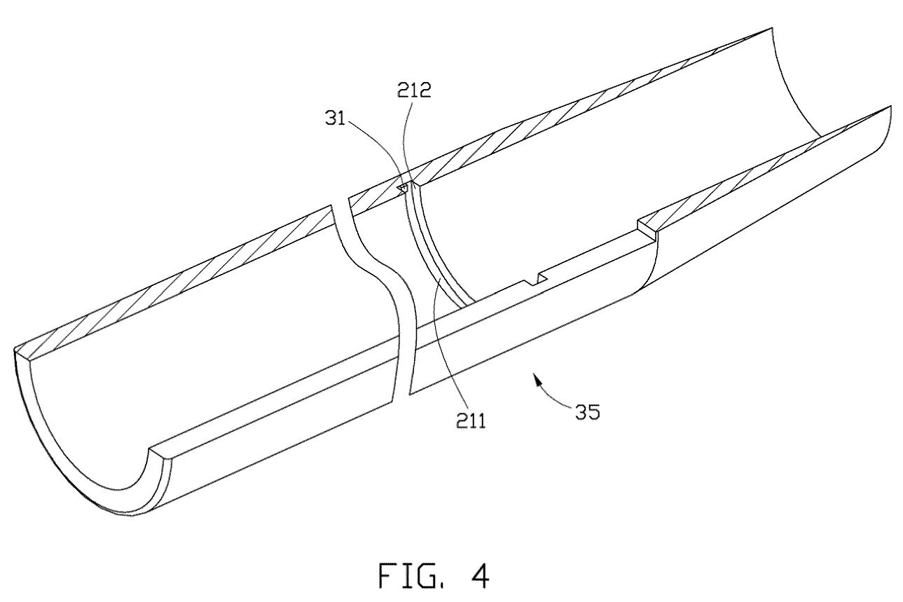

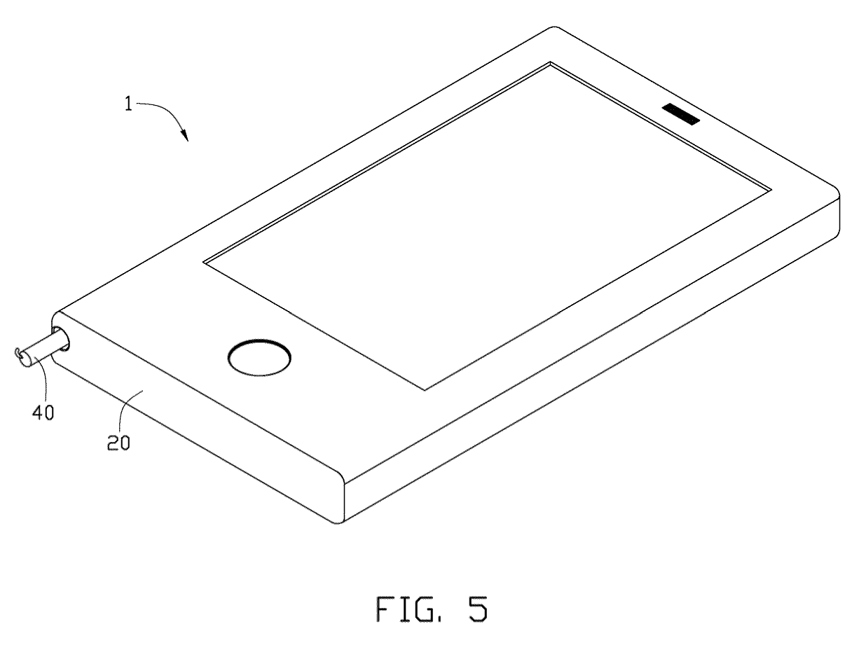

Referring to FIG. 4 and FIG. 5, a groove 211 is formed in the inner surface of the socket 35, and is configured for receiving the ring 42. A plurality of grooves 212 is formed in a bottom surface of the groove 211. Each of the grooves 212 is aligned with one of the notches 21, is configured for placement of a trigger 31 therein, and is configured for receiving the protrusion 43. Each of the triggers 31 will be pressed by the protrusion 43 when the hook 44 is engaged with each of the notches 21 in turn. In other words the user can insert the stylus 40 into the socket 35 then rotate the stylus 40 until the hook 44 is engaged with one of the notches 21 to press one of the triggers 31 aligned with the engaged notch 21.

In some other embodiments, the groove 212 may be directly formed in the inner surface of the socket 35, and the groove 211 omitted.

When user want to selectively supply power for one of the power consuming module 34, the user inserts the stylus 40 into the socket 35, and rotates the stylus 40 manually until the hook 44 is engaged with one of the notches 21 and one of the triggers 31 is pressed by the protrusion 43. The power supply controlling module 36 identifies the pressed trigger 31, reads the relationship table from the storage unit 32, and controls the power supplying module 37 to supply power for the power consuming module 34 associated with the pressed trigger 31. In the exemplary embodiment, the trigger 31 is a pressure sensor. In other embodiments, the trigger 31 may be a trigger switch, etc.

In addition, if the stylus 40 is not inserted into the socket 35, or is inserted but the hook 44 is not engaged with one of the notches 21, then no triggers 31 are pressed, and the power supply controlling module 36 will control the power supplying module 37 to supply power for all power consuming modules 34.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
a main body and a stylus, wherein
the main body comprises:
a plurality of notches formed in a side plate of the main body;
a plurality of triggers;
a plurality of power consuming modules;
a power supply controlling module;
a power supplying module;
a storage unit configured for storing a relationship table which records a relationship between the triggers and the power consuming modules, wherein each of the triggers associated with one of the power consuming modules; and
a socket configured for receiving the stylus, wherein the socket defines a plurality of grooves on an inner surface thereof, and each of the grooves is aligned with one of the notches, and configured for placing a trigger; and
the stylus comprises:
a shank, a protrusion and a hook, wherein the protrusion is protruded from the circumferential surface of the shank, the hook is formed in an end of the stylus, and is aligned with the protrusion;
wherein when the stylus is inserted into the socket, and the hook is engaged with one of the notches, one of the triggers is pressed by the protrusion, the power supply controlling module is configured for identifying the pressed trigger, reading the relationship table from the storage unit, and controlling the power supplying module to supply power for the power consuming module associated with the pressed trigger.

2. The electronic device as described in claim 1, wherein when the stylus is inserted into the socket and the hook is not engaged with one of the notches, with no trigger being pressed, the power supply controlling module is further configured for controlling the power supplying module to supply power for all power consuming modules.

3. The electronic device as described in claim 1, wherein a ring-shaped groove is formed on the inner surface of the socket, and configured for receiving the ring; a groove for receiving the protrusion is formed on a bottom surface of the ring-shaped groove.

4. The electronic device as described in claim 1, wherein the triggers are pressure sensors.

5. The electronic device as described in claim 1, wherein the shank is a cylinder in shape.

6. The electronic device as described in claim 1, wherein the socket is a hollow cylinder.

7. The electronic device as described in claim 1, wherein the triggers are trigger switches.

8. The electronic device as described in claim 1, wherein a ring are extended from the circumferential surface of the shank, the protrusion is protruded from the circumferential surface of the ring.

9. The electronic device as described in claim 8, wherein at least one of the ring and the protrusions are elastic.
